(19) United States
(12) Patent Application Publication
(10) Pub. No.: US 2004/0027228 A1
(43) Pub. Date: Feb. 12, 2004

(54) Strain gauge devices

(76) Inventor: Robert T.A. Stevens, Lancing (GB)

Correspondence Address: Mark D Simpson, Synnestvedt & Lechner, 2600 Aramark Tower, 1101 Market Street, Philadelphia, PA, 19107-2950, US

(21) Appl. No.: 10/398,309

(22) PCT Filed: Oct. 5, 2001
(86) PCT No.: PCT/GB01/04435

(51) Int. Cl. G01L 1/22

(52) U.S. Cl. 338/2

(57) ABSTRACT

The strain gauges comprise an insulated substrate (6) carrying metallic layers (1-4) formed as a labyrinthine patterns, characterised in that the metallic layers are carried on opposite sides of the substrate in a substantially matching relationship mounted on a Platform (7). The platform may carry two sets of gauges set at right angles to each other so as to sense movement in two dimensions. The platform may be designed to emulate a snowboard surface, a skateboard surface or a pair of skis.

This invention relates to improved strain gauge devices and to their use as input devices for games and training using computers and similar equipment.

Strain gauges comprise one or more electrical conductors whose resistance changes when deformation occurs. Such gauges consist of wire or foil conductors bonded or otherwise firmly attached to an item whose deformation is to be measured or they may be deposited on a substrate which is subsequently bonded to the item under measurement.

Many home entertainment games, arcade games and simulators for training purposes use a human derived input system which, as an electrical signal, is used to control a computer generated display. In its simplest form the input signal is a generated in response to a varying resistance element. The element is customarily a potentiometer of conventional design with a resistive element and a sliding electrode which contacts its surface. The movement of the slider may be by direct manual control as in the so-called “joy stick” controllers or a more sophisticated system in which a platform is coupled to a potentiometer slider by a mechanical linkage such as a gear train or bowden cable. The mechanical linkages tend to fail under constant use and can be unreliable or have a short useful life.

The present invention provides an input system for computers and their displays avoiding the use of mechanical couplings.

According to the present invention there is provided a strain gauge comprising an insulated substrate carrying metallic layers formed as a labyrinthine pattern, characterised in that the metallic layers are carried on opposite sides of the substrate in a substantially matching relationship mounted on a platform.

Suitable strain gauges are described in United Kingdom patent application 0024368.3.

The strain gauge connections are preferably taken to a dc amplifier and, optionally, a digital to analogue converter before being passed to a an input device. Early amplification and conversion to digital form reduces the corruption of the changing resistance values of the gauge when carried by long leads to an input device.

In a most preferred embodiment of the gauge according to the invention the substrate carrying the gauge elements forms part of a platform which can take the weight of a human being and conforms in shape and size to known human carriers such as snow boards and skateboards. Such platforms must be able to withstand varying loads in the region of 80 kg or greater. The platform preferably carries two sets of gauges set at right angles to each other so as to sense movement in two dimensions. In such an arrangement a mass carried by the platform, such as a standing human, will cause changes in the two sets of gauges as its centre of gravity moves even though the area of contact remains static. A human watching a screen can thus move its body to in a manner that compensates a view seen on a screen. Such an arrangement can simulate a snowboard on which the rider is fixed to the board and steers it by movement of the body.

As described in application 0024368.3, the insulating substrate is preferably a synthetic resin composition reinforced to provide strength but sufficiently resilient to avoid cracking when subjected to moderate stresses and strains. Glass reinforced epoxy resin is the preferred substrate. The metal forming the labarinthine pattern is preferably bonded to the opposite surfaces of the substrate before the formation of the pattern. The metal layer may be applied as a thin foil bonded by an adhesive film or formed by vacuum deposition directly on to each surface of the substrate. The conducting foil pattern may be created by conventional means such as coating with a photoresist composition followed by actinic light exposure to form a resist pattern and etching away the areas unprotected by the resist. The metal may be a high resistance alloy, such as copper/nickel or nickel/chromium alloy, or a pure metal such as copper. The use of substantially matching metal patterns on each side of the substrate enables considerable compensation for resistance changes due to variations in temperature to be obtained. The metal patterns are connected so that changes in resistance balance each other. A particular advantage of this arrangement is that inexpensive and easily managed metals, such as copper, may be used for the pattern in spite of their comparatively high temperature coefficient of resistance.

The labyrinthine metal pattern on the substrate may take any conventional form and position. The pattern is duplicated on each side of the substrate so that the conductors forming the gauge may be connected in a bridge configuration in a manner that compensates resistance changes caused by variations in temperature.

In a preferred embodiment the substrate of the strain gauge according to the invention includes more than one gauge set. A pair of gauge sets may be connected in a bridge configuration in a manner that detects the bending movement of the substrate where a particular gauge is situated. The substrate is bonded, bolted or otherwise attached to the underside of the platform on which the load is situated. The platform may be designed to emulate a snowboard surface or that of a skateboard.

In a most preferred embodiment the substrate of the strain gauge according to the invention includes a conductor pattern which connects the resistance elements to an amplifier so that when electrical power is supplied a variable voltage signal output can be obtained and fed to an associated piece of equipment such as a microprocessor and display system. The signals will vary in accordance with movements of the load. The amplifier may be constructed from discrete components but is preferably in the form of an integrated circuit. In either case the input, output and necessary power supplies are connected through the conductor pattern on the substrate. This arrangement reduces to a minimum the number of connections required to the associated gauge pattern. The preferred configuration of the integrated circuit amplifies is the surface mount form.

The arrangement described enables output of the bridge circuit comprised by the conductor patterns to be amplified at source and supplied at a suitable level for transmission by ordinary wiring to associated equipment. In some cases it may be convenient to include an analogue to digital conversion circuit within the amplifier integrated circuit package or in a separate package so that the resistance changes are supplied in a digitally coded form. In other cases it may be convenient to include voltage to resistance conversion circuits among the amplifier and its associated circuits. Such an arrangement enables the strain gauge system of the invention to be a direct replacement for a variable resistance device using potentiometers with mechanical linkages. In alternative applications it may be convenient to include a microprocessor, switching and dual vibration motor circuits within the amplifier integrated circuit package or in a separate package so as to send a signal from the assembly to the associated equipment having the required protocol.

In order that the invention may be clearly understood it will now be described with reference to the accompanying drawings in which:

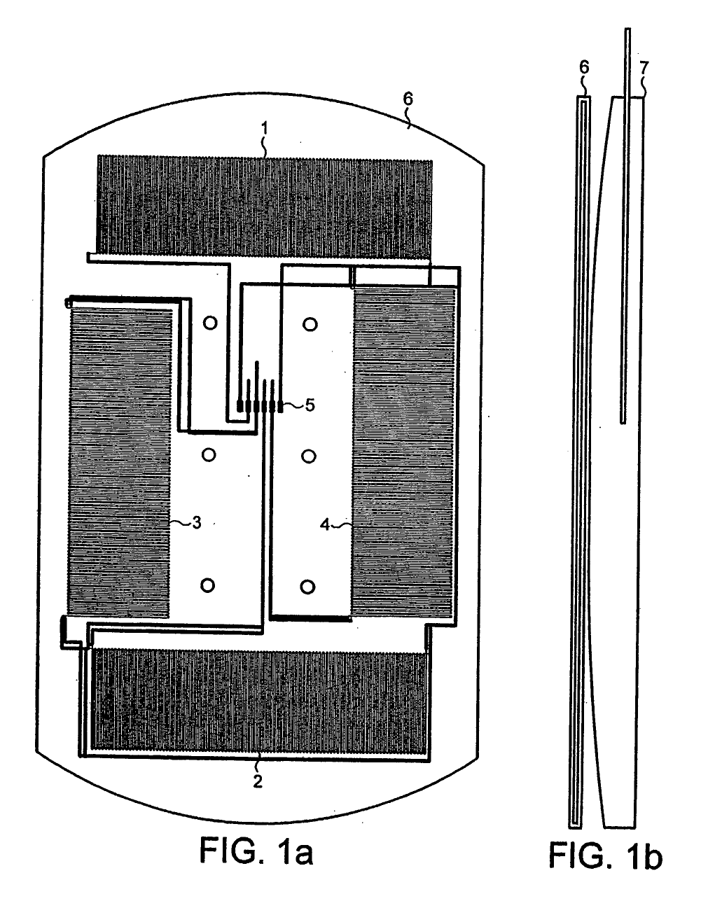

FIG. 1a is a plan view of the surface of a strain gauge assembly according to the invention carrying four strain gauge sets of metal patterns for forming two full bridge networks,

FIG. 1b is a side view of the strain gauge assembly shown in FIG. 1a.

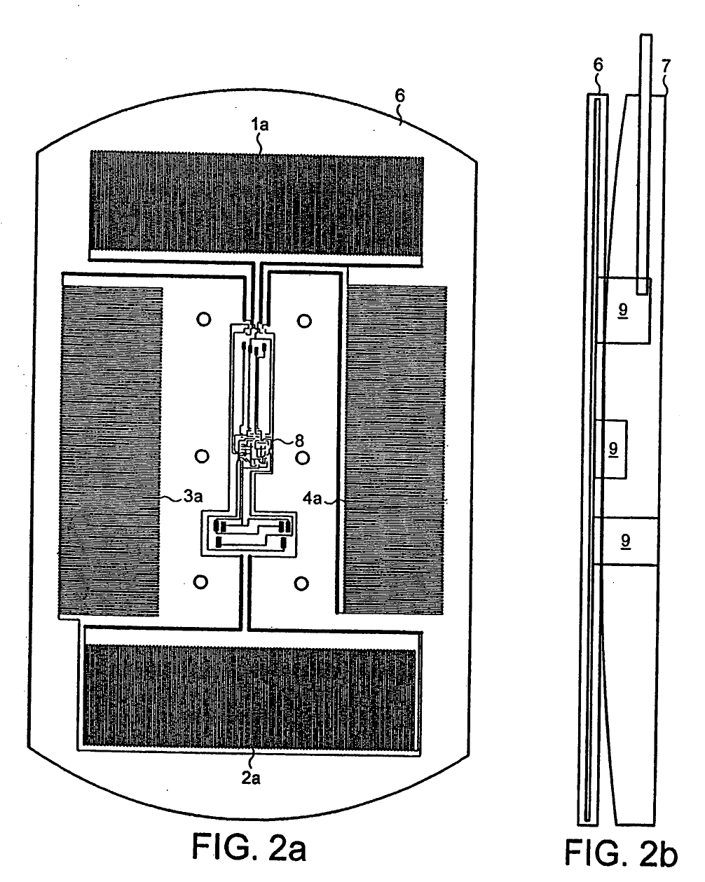

FIG. 2a is a plan view of the under surface of a strain gauge assembly according to the invention carrying four strain gauge sets of metal patterns for forming two full bridge networks and associated conductors for connection to integrated circuit amplifiers,

FIG. 2b is a side view of the strain gauge assembly shown in FIG. 2a,

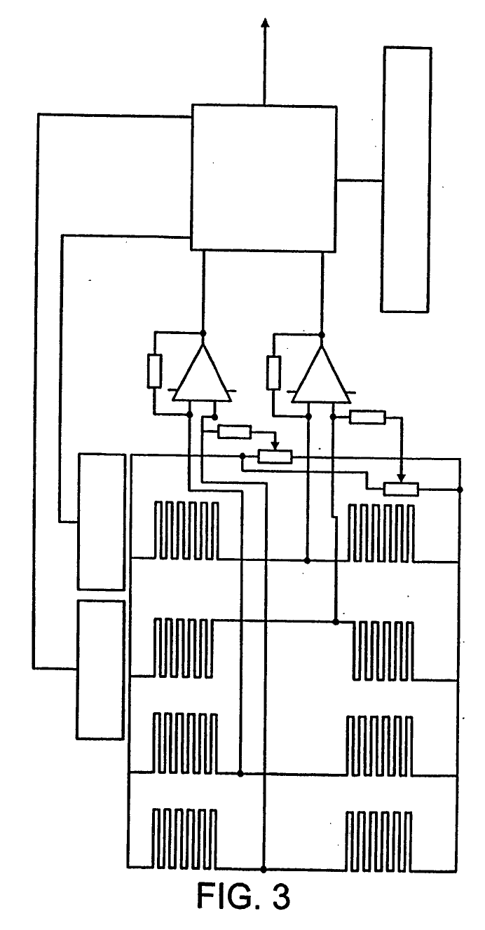

FIG. 3 is an outline circuit diagram of the connections and output for connection to a computer system of the type called a “playstation”, and

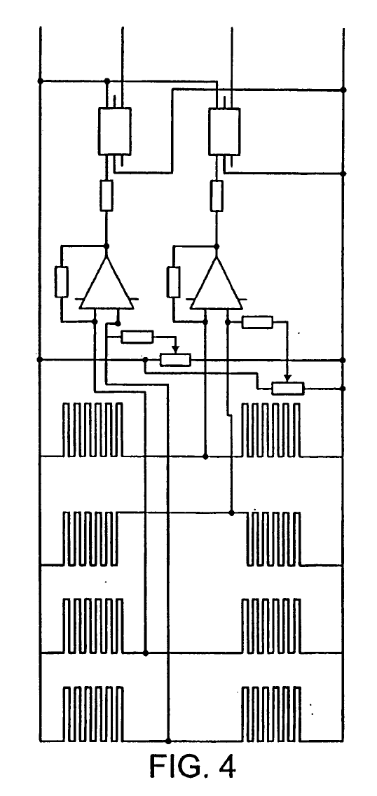

FIG. 4 is an outline circuit diagram of the connections and output for connection to a PC computer system.

A strain gauge assembly consists of four gauges formed as labyrinthine metal patterns, see FIG. 1a, in which pairs of gauges 1 and 2 with 3 and 4 are connected through printed circuit leads to a point in the substrate 5 where they can pass through it. The substrate 6, see FIG. 1b, lies on a curved base 7 so that it will bend across the base 7 as any load placed on it moves. The underside of the substrate, see FIG. 2a, carries a complementary strain gauge assembly consisting of pairs of gauges 1′ and 2′ with 3′ and 4′. The gauges 1′ to 4′ are connected through printed circuit leads to an amplifier assembly 8. As seen from FIG. 2b, the substrate 6 lies on a curved base 7 so that it will bend across the base 7 as any load placed on it moves. The base 7 includes cavities 9 to accommodate the integrated circuits and other components of the amplifier assembly 8.

The circuit arrangements for providing a single digital output or a balanced analogue resistive output are shown in FIGS. 3 and 4 using conventional symbols.

In a further embodiment two sets of gauge assemblies may be fitted side by side on the platform. The player has a foot strapped to each gauge assembly. Such an arrangement enables movements of the body when skiing with conventional skis to be simulated.

Hand controls, such as a pair of vertical rods fitted with strain gauges, enable the skier to emulate the use of ski sticks for braking, turning, etc. when moving on a ski slope.

1. A strain gauge comprising an insulated substrate carrying metallic layers formed as a labyrinthine pattern, characterised in that the metallic layers are carried on opposite sides of the substrate in a substantially matching relationship mounted on a platform.

2. The strain gauge as claimed in claim 1, characterised in that the strain gauge connections are taken to a dc amplifier.

3. The strain gauge as claimed in claim 1 or claim 2, characterised in that the strain gauge connections are taken to a digital to analogue converter.

4. The strain gauge as claimed in claim 2 or claim 3, characterised in that the dc amplifier and/or the digital to analogue converter are mounted on the insulating substrate with their inputs proximate to the strain gauge connections.

5. The strain gauge as claimed in claim 4, characterised in that the substrate of the strain gauge includes a conductor pattern which connects the resistance elements to an amplifier so that when electrical power is supplied a variable voltage signal output can be obtained and fed to an associated piece of equipment such as a microprocessor and display system.

6. The strain gauge as claimed in any of the claims 2 to 5, characterised in that the substrate carrying the gauge elements forms part of a platform which can take the weight of a human being and conforms in shape and size to known human carriers such as snow boards and skateboards.

7. The strain gauge as claimed in claim 6, characterised in that the platform is able to withstand varying loads in the region of 80 kg or greater.

8. The strain gauge as claimed in claim 6 or claim 7, characterised in that the platform carries two sets of gauges set at right angles to each other so as to sense movement in two dimensions.

9. The strain gauge as claimed in claim 6, characterised in that an associated viewing screen receives processed signals which provide a scene whose orientation varies with the movement of a load, such as a human, carried by the platform.

10. The strain gauge as claimed in any of the preceding claims, characterised in that the insulating substrate is a synthetic resin composition reinforced to provide strength but sufficiently resilient to avoid cracking when subjected to moderate stresses and strains.

11. The strain gauge as claimed in claim 10, characterised in that the substrate is glass reinforced epoxy resin.

12. The strain gauge as claimed in any of the preceding claims, characterised in that the metal forming the labarinthine pattern is bonded to the opposite surfaces of the substrate before the formation of the pattern.

13. The strain gauge as claimed in any of the preceding claims, characterised in that the conducting metal foil pattern is a high resistance alloy, such as copper/nickel or nickel/chromium alloy.

14. The strain gauge as claimed in any of the preceding claims, characterised in that the conducting metal foil pattern is copper.

15. The strain gauge as claimed in any of the preceding claims, characterised in that the substrate of the strain gauge includes more than one gauge set.

16. The strain gauge as claimed in claim 15, characterised in that a pair of gauge sets are connected in a bridge configuration in a manner that detects the bending movement of the substrate where a particular gauge is situated.

17. The strain gauge as claimed in any of the preceding claims 5 to 16, characterised in that the substrate is bonded, bolted or otherwise attached to the underside of the platform on which the load is situated.

18. The strain gauge as claimed in any of the preceding claims, characterised in that the platform is designed to emulate a snowboard surface.

19. The strain gauge as claimed in any of the claims 5 to 17, characterised in that the platform is designed to emulate a skateboard surface.

20. The strain gauge as claimed in any of the claims 5 to 17, characterised in that the platform is designed to emulate a pair of skis.

21. The strain gauge as claimed in claim 4, characterised in that the amplifier is constructed from discrete components.

22. The strain gauge as claimed in claim 4, characterised in that the amplifier is in the form of an integrated circuit.

23. The strain gauge as claimed in claim 4, characterised in that the input, output and necessary power supplies are connected through the conductor pattern on the substrate.

24. The strain gauge as claimed in any of the preceding claims 5 to 23, characterised in that the substrate includes a microprocessor, switching and dual vibration motor circuits within the amplifier integrated circuit package to send a signal from the strain gauge assembly to associated equipment having the required protocol.
